(19) United States
(12) Patent Application Publication
(10) Pub. No.: US 2022/0114459 A1
(43) Pub. Date: Apr. 14, 2022

(54) DETECTION OF ASSOCIATIONS BETWEEN DATASETS

(71) Applicant: International Business Machines Corporation, Armonk, NY (US)

(72) Inventors: Manish Anand Bhide, Hyderabad (IN); Pranay Kumar Lohia, Bhagalpur (IN)

(21) Appl. No.: 17/068,856

(22) Filed: Oct. 13, 2020

(51) Int. Cl. G06N 5/04; G06N 20/00

(52) U.S. Cl. CPC G06N 5/04; G06N 20/00

(57) ABSTRACT

A computer device identifies (i) a dataset, (ii) a set of output class determinations made for data entries of the dataset by a computer decision algorithm, and (iii) an undesired disparity between output class determinations resulting from a first value of a first attribute of the dataset and output class determinations resulting from a second value of the first attribute. The computing device determines a value of a second attribute of the dataset is contributing to the undesired disparity by: providing an association rule mining model (i) a first group of the data entries having the first value of the first attribute, and (ii) a second group of the data entries having the second value of the first attribute, and selecting the value of the second attribute from a set of candidate attribute values produced by the association rule mining model based, at least in part, on a lift calculation.

### BACKGROUND OF THE INVENTION

The present invention relates generally to the field of analyzing large datasets and more particularly to detecting associations between attributes in datasets.

Generally, with large datasets, computer decision algorithms may tend to select a particular group of data entries routinely over other groups of data entries. The disproportionate selection of data entries may cause a disparate impact and may also be viewed as being dependent from other parameters.

### SUMMARY

Embodiments of the present invention provide a method, system, and program product.

A first embodiment encompasses a method. One or more processors identify (i) a dataset, (ii) a set of output class determinations made for data entries of the dataset by a computer decision algorithm, and (iii) an undesired disparity between output class determinations resulting from a first value of a first attribute of the dataset and output class determinations resulting from a second value of the first attribute. The one or more processors determine that a value of a second attribute of the dataset is contributing to the undesired disparity, by: providing to an association rule mining model: (i) a first group of the data entries having the first value of the first attribute, and (ii) a second group of the data entries having the second value of the first attribute, and selecting the value of the second attribute from a set of candidate attributes and values produced by the association rule mining model based, at least in part, on a lift calculation.

A second embodiment encompasses a computer program product. The computer program product includes one or more computer-readable storage media and program instructions stored on the one or more computer-readable storage media. The program instructions include program instructions to identify (i) a dataset, (ii) a set of output class determinations made for data entries of the dataset by a computer decision algorithm, and (iii) an undesired disparity between output class determinations resulting from a first value of a first attribute of the dataset and output class determinations resulting from a second value of the first attribute. The program instructions include program instructions to determine that a value of a second attribute of the dataset is contributing to the undesired disparity, by: providing to an association rule mining model: (i) a first group of the data entries having the first value of the first attribute, and (ii) a second group of the data entries having the second value of the first attribute, and selecting the value of the second attribute from a set of candidate attributes and values produced by the association rule mining model based, at least in part, on a lift calculation.

A third embodiment encompasses a computer system. The computer system includes one or more computer processors, one or more computer-readable storage media, and program instructions stored on the computer-readable storage media for execution by at least one of the one or more processors. The program instructions include program instructions to identify (i) a dataset, (ii) a set of output class determinations made for data entries of the dataset by a computer decision algorithm, and (iii) an undesired disparity between output class determinations resulting from a first value of a first attribute of the dataset and output class determinations resulting from a second value of the first attribute. The program instructions include program instructions to determine that a value of a second attribute of the dataset is contributing to the undesired disparity, by: providing to an association rule mining model: (i) a first group of the data entries having the first value of the first attribute, and (ii) a second group of the data entries having the second value of the first attribute, and selecting the value of the second attribute from a set of candidate attributes and values produced by the association rule mining model based, at least in part, on a lift calculation.

### BRIEF DESCRIPTION OF THE SEVERAL VIEWS OF THE DRAWINGS

FIG. 1 is a functional block diagram illustrating a computing environment, in which a computing device determines associations between data entries, in accordance with an exemplary embodiment of the present invention.

FIG. 2 illustrates operational processes of executing a system for determining associated values in large datasets, on a computing device within the environment of FIG. 1, in accordance with an exemplary embodiment of the present invention.

FIG. 3 depicts a cloud computing environment according to at least one embodiment of the present invention.

FIG. 4 depicts abstraction model layers according to at least on embodiment of the present invention.

FIG. 5 depicts a block diagram of components of one or more computing devices within the computing environment depicted in FIG. 1, in accordance with an exemplary embodiment of the present invention.

### DETAILED DESCRIPTION

Detailed embodiments of the present invention are disclosed herein with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the present invention recognize that computer decision algorithms can analyze large sets of data and determine output classes for that data based on a variety of factors, or attributes. In some cases, the users and/or developers of such algorithms may prefer to avoid disparate output class determinations for particular values of particular attributes, for any of a wide variety of reasons. However, in many cases, a single value of a single attribute may not be enough to fully characterize a disparate output class determination, and values of additional, related attributes may prove to be correlated to the single value of the single attribute, but may not be immediately apparent to the user. Embodiments of the present invention utilize machine logic to identify such associated attributes and values in large sets of data. The resulting identifications can then be used to improve the efficacy and fairness of computer decision algorithms for making decisions using those large sets of data in the future.

Embodiments of the present invention provide technological improvements over known computer decision and/or association detection systems in several meaningful ways. For example, various embodiments of the present invention improve over existing systems by providing more useful results—i.e., decisions that are more closely based on desired attributes, and identifications of associated attributes that are more accurate than known systems, are more useful to end users and are thus improvements over existing systems. But further, various embodiments of the present invention also provide important improvements to the technological operations of the underlying systems generating these results. For example, detecting associated attributes in large sets of data (or “Big Data” environments) can be a very processor and memory intensive operation, and embodiments of the present invention, by providing more efficient attribute detection, reduce the amount of processor and memory resources needed compared to conventional systems. Further, by using the attribute detection features of embodiments of the present invention to improve computer decision algorithms, various embodiments of the present invention reduce the number of unacceptable decisions generated by such algorithms, thus decreasing the amount of decisions that need to be discarded which, in turn, results in a more efficient consumption of computing resources.

The present invention will now be described in detail with reference to the Figures.

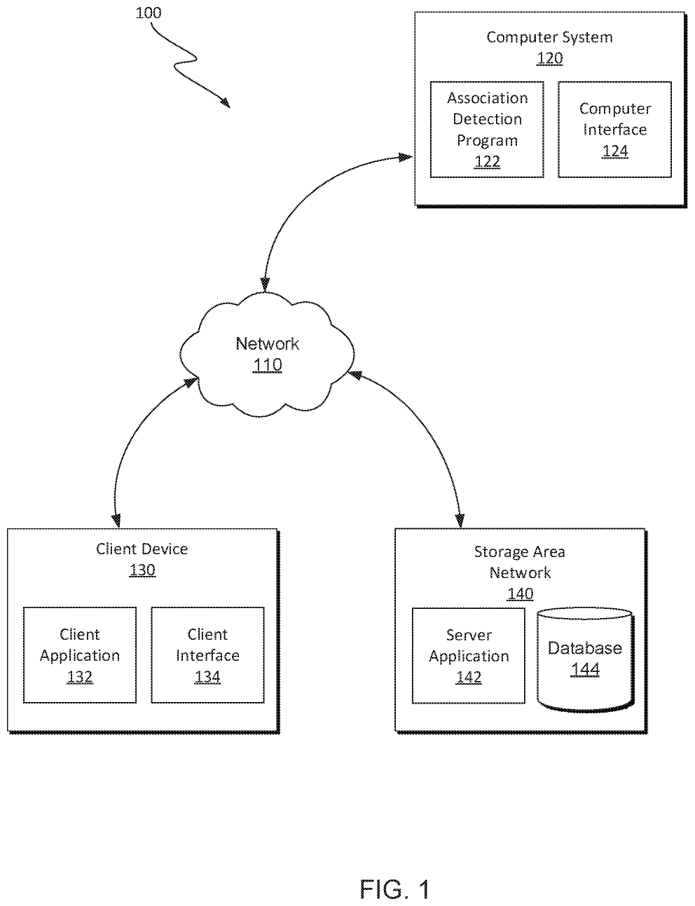

FIG. 1 is a functional block diagram illustrating computing environment, generally designated 100, in accordance with one embodiment of the present invention. Computing environment 100 includes computer system 120, client device 130, and storage area network (SAN) 140 connected over network 110. Computer system includes association detection program 122 and computer interface 124. Client device 130 includes client application 132 and client interface 134. Storage area network (SAN) 140 includes server application 142 and database 144.

In various embodiment of the present invention, computer system 120 is a computing device that can be a standalone device, a server, a laptop computer, a tablet computer, a netbook computer, a personal computer (PC), a personal digital assistant (PDA), a desktop computer, or any programmable electronic device capable of receiving, sending, and processing data. In general, computer system 120 represents any programmable electronic device or combination of programmable electronic devices capable of executing machine readable program instructions and communications with various other computer systems (not shown). In another embodiment, computer system 120 represents a computing system utilizing clustered computers and components to act as a single pool of seamless resources. In general, computer system 120 can be any computing device or a combination of devices with access to various other computing systems (not shown) and is capable of executing association detection program 122 and computer interface 124. Computer system 120 may include internal and external hardware components, as described in further detail with respect to FIG. 6.

In this exemplary embodiment, association detection program 122 and computer interface 124 are stored on computer system 120. However, in other embodiments, association detection program 122 and computer interface 124 are stored externally and accessed through a communication network, such as network 110. Network 110 can be, for example, a local area network (LAN), a wide area network (WAN) such as the Internet, or a combination of the two, and may include wired, wireless, fiber optic or any other connection known in the art. In general, network 110 can be any combination of connections and protocols that will support communications between computer system 120, client device 130, and SAN 140, and various other computer systems (not shown), in accordance with desired embodiments of the present invention.

In the embodiment depicted in FIG. 1, association detection program 122, at least in part, has access to client application 132 and can communicate data stored on computer system 120 to client device 130, SAN 140, and various other computer systems (not shown). More specifically, association detection program 122 defines a user of computer system 120 that has access to data stored on client device 130 and/or database 144.

Association detection program 122 is depicted in FIG. 1 for illustrative simplicity. In various embodiments of the present invention, association detection program 122 represents logical operations executing on computer system 120, where computer interface 124 manages the ability to view these logical operations that are managed and executed in accordance with association detection program 122. In some embodiments, association detection program 122 represents a system that processes and analyzes data to detect associations between values of different attributes.

Computer system 120 includes computer interface 124. Computer interface 124 provides an interface between computer system 120, client device 130, and SAN 140. In some embodiments, computer interface 124 can be a graphical user interface (GUI) or a web user interface (WUI) and can display, text, documents, web browsers, windows, user options, application interfaces, and instructions for operation, and includes the information (such as graphic, text, and sound) that a program presents to a user and the control sequences the user employs to control the program. In some embodiments, computer system 120 accesses data communicated from client device 130 and/or SAN 140 via a client-based application that runs on computer system 120. For example, computer system 120 includes mobile application software that provides an interface between computer system 120, client device 130, and SAN 140. In various embodiments, computer system 120 communicates the GUI or WUI to client device 130 for instruction and use by a user of client device 130.

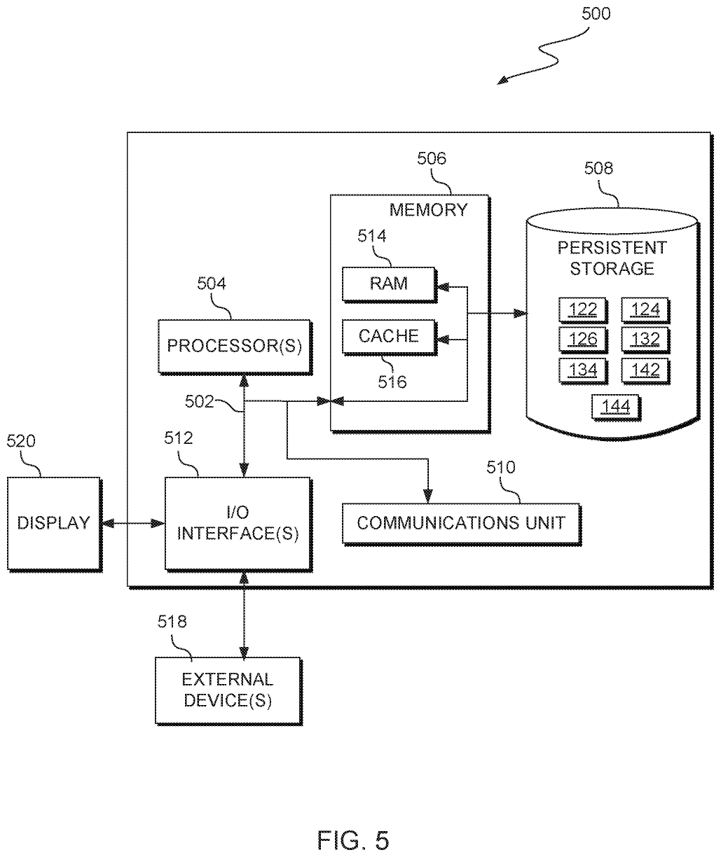

In various embodiments, client device 130 is a computing device that can be a standalone device, a server, a laptop computer, a tablet computer, a netbook computer, a personal computer (PC), a personal digital assistant (PDA), a desktop computer, or any programmable electronic device capable of receiving, sending and processing data. In general, computer system 120 represents any programmable electronic device or combination of programmable electronic devices capable of executing machine readable program instructions and communications with various other computer systems (not shown). In another embodiment, computer system 120 represents a computing system utilizing clustered computers and components to act as a single pool of seamless resources. In general, computer system 120 can be any computing device or a combination of devices with access to various other computing systems (not shown) and is capable of executing client application 132 and client interface 134. Client device 130 may include internal and external hardware components, as described in further detail with respect to FIG. 5.

Client application 132 is depicted in FIG. 1 for illustrative simplicity. In various embodiments of the present invention client application 132 represents logical operations executing on client device 130, where client interface 134 manages the ability to view these various embodiments, and client application 132 defines a user of client device 130 that has access to data stored on computer system 120 and/or database 144.

Storage area network (SAN) 140 is a storage system that includes server application 142 and database 144. SAN 140 may include one or more, but is not limited to, computing devices, servers, server-clusters, web-servers, databases and storage devices. SAN 140 operates to communicate with computer system 120, client device 130, and various other computing devices (not shown) over a network, such as network 110. For example, SAN 140 communicates with association detection program 122 to transfer data between computer system 120, client device 130, and various other computing devices (not shown) that are not connected to network 110. SAN 140 can include internal and external hardware components as described with respect to FIG. 6. Embodiments of the present invention recognize that FIG. 1 may include any number of computing devices, servers, databases, and/or storage devices, and the present invention is not limited to only what is depicted in FIG. 1. As such, in some embodiments some of the features of computer system 120 are included as part of SAN 140 and/or another computing device.

Additionally, in some embodiments, SAN 140 and computer system 120 represent, or are part of, a cloud computing platform. Cloud computing is a model or service delivery for enabling convenient, on demand network access to a shared pool of configurable computing resources (e.g., networks, network bandwidth, servers, processing, memory, storage, applications, virtual machines, and service(s) that can be rapidly provisioned and released with minimal management effort or interaction with a provider of a service. A cloud model may include characteristics such as on-demand self-service, broad network access, resource pooling, rapid elasticity, and measured service, can be represented by service models including a platform as a service (PaaS) model, an infrastructure as a service (IaaS) model, and a software as a service (SaaS) model, and can be implemented as various deployment models as a private cloud, a community cloud, a public cloud, and a hybrid cloud. In various embodiments, SAN 140 represents a database or website that includes, but is not limited to, data associated with weather patterns.

SAN 140 and computer system 120 are depicted in FIG. 1 for illustrative simplicity. However, it is to be understood that, in various embodiments, SAN 140 and computer system 120 can include any number of databases that are managed in accordance with the functionality of association detection program 122 and server application 142. In general, database 144 represents data and server application 142 represents code that provides an ability to use and modify the data. In an alternative embodiment, association detection program 122 can also represent any combination of the aforementioned features, in which server application 142 has access to database 144. To illustrate various aspects of the present invention, examples of server application 142 are presented in which association detection program 122 represents one or more of, but is not limited to, determinations of associations between attributes.

In some embodiments, server application 142 and database 144 are stored on SAN 140. However, in various embodiments, server application 142 and database 144 may be stored externally and accessed through a communication network, such as network 110, as discussed above.

Embodiments of the present invention include a computer decision system that assigns data entries to output classes based on values of the data entries' respective attributes. In various embodiments, computer system 120 identifies output class determinations that are biased or partial with respect to a value of a particular attribute. For example, in various embodiments, association detection program 122 identifies whether two or more groups of data entries are receiving a different classification result (e.g., output class) based on the fact that the groups of data entries have different values for the particular attribute. For example, in various embodiments, if the ratio of a favorable outcome of a first group of data entries having a first value of a particular attribute divided by the ratio of a favorable outcome of a second group of data entries having a second value of the particular attribute, or vice versa, is less than 0.8, association detection program 122 determines that a disparate impact has occurred.

Embodiments of the present invention provide that in some cases, attributes may include protected categories (or protected classes) including, but not limited to, age, gender, race, national origin, religion, etc., and that the system may identify groups within protected categories that are receiving disparate classifications. For example, in one embodiment, where age—a protected class—is the “particular attribute”, if the ratio of home loans provided to individuals under the age of twenty-five (25) as compared to home loans provided to individuals greater than or equal to twenty-five (25) is below 0.8, then individuals under the age of 25 are disparately impacted.

In various embodiments of the present invention, association detection program 122 determines whether groups receiving disparate classification decisions include other, associated attribute values that are contributing to the disparate classification decision, beyond a known value/attribute combination. In these embodiments, the attribute value known to contribute to the disparate classification decision (such as age being under 25) may be provided by a user, and association detection program 122 then determines additional attributes and values that may be associated to the provided attribute value, and responds to the user with an identification of the determined additional attributes and values.

In various embodiments, association detection program 122 receives a large set of data containing a plurality of data entries having particular attributes and respective values. In various embodiments, association detection program 122 also receives input data from a user that includes, but is not necessarily limited to, (i) a particular attribute for which partial/disparate classification decisions is not desired (e.g., age), (ii) a first group of data entries having a first value (or group of values) of the particular attribute (e.g., under 25), (iii) a second group of data entries having a second value (or group of values) of the particular attribute (e.g., equal to or greater than 25), and (iv) an identification of which classification(s) (i.e., output class(es)) are considered to be favorable (e.g., approval for a home loan).

In various embodiments, association detection program 122 analyzes the user input to identify whether one or more additional attributes are associated with the particular attribute with respect to the receipt of an unfavorable classification decision. Stated another way, association detection program 122 determines whether one or more additional attributes, when combined with the particular attribute, result in an even higher likelihood of receiving an unfavorable classification decision.

In various embodiments, association detection program 122 utilizes association rule learning to identify an association between the values of a particular attribute and a second attribute in relation to the output class. In various embodiments, association rule learning includes a rule-based machine learning model to identify relations between such associated attributes and values in large sets of data. In various embodiments, association detection program 122 analyzes the large datasets and identifies the values of the particular attribute and values of additional attributes in the data entries, and the determination of the output class for each value of the particular attributes and the additional attributes. In various embodiments, association detection program 122 generates an association frequency map of the various attributes and their values. In various embodiments, association detection program 122 utilizes a lift value to determine whether a first value of the particular attribute (the “first attribute”) has an association to a third value of a second attribute, for example. In various embodiments, the lift value is calculated by Equation (1), below. Embodiments of the present invention provide that a high lift value indicates a high association between the first value of the first attribute and the third value of the second attribute.

data entries (i.e., rows) where the first value and third value co-occurred/(data entries (i.e., rows) where the first value occurred)×(data entries (i.e., rows) where the third value occurred) Equation (1):

In various embodiments, association detection program 122 calculates the lift value and analyzes the lift value to determine whether a high association or low association exists between the first value of the first attribute (the “specified attribute”) and the third value of the second attribute. In various embodiments, association detection program 122 further calculates lift values between the first value of the first attribute and values of a plurality of other additional attributes. In various embodiments, association detection program 122 identifies a threshold lift value and selects the associated attributes having lift values exceeding the threshold for further processing. In various embodiments, the same process occurs for the second value of the first attribute, resulting in the selection of associated attributes having high lift values exceeding the threshold with respect to the second value of the first attribute.

In various embodiments, association detection program 122 then performs partiality analyses on: (i) the first value of the first attribute and each of the identified values for its respectively selected associated attributes, (ii) the second value of the first attribute and each of the identified values for its respectively selected associated attributes. In various embodiments, these partiality analyses use the same metric used to determine partiality in the values of the first attribute. The results of these analyses identify whether the associated attributes are also receiving a partial determination with respect to the output class.

In various embodiments, association detection program 122 identifies the associated attributes receiving partial determinations and responds to the user request by providing a summary to the user of client device 130. In various embodiments, the summary instructs the user to further analyze the data and make an informed decision on various parameters that could positively impact the partial determination identified. Embodiments of the present invention provide that the coaching of the user is provided to allow the user to make an impartial determination of the output class for the attribute values determined to be associated with the first and second values of the first attribute.

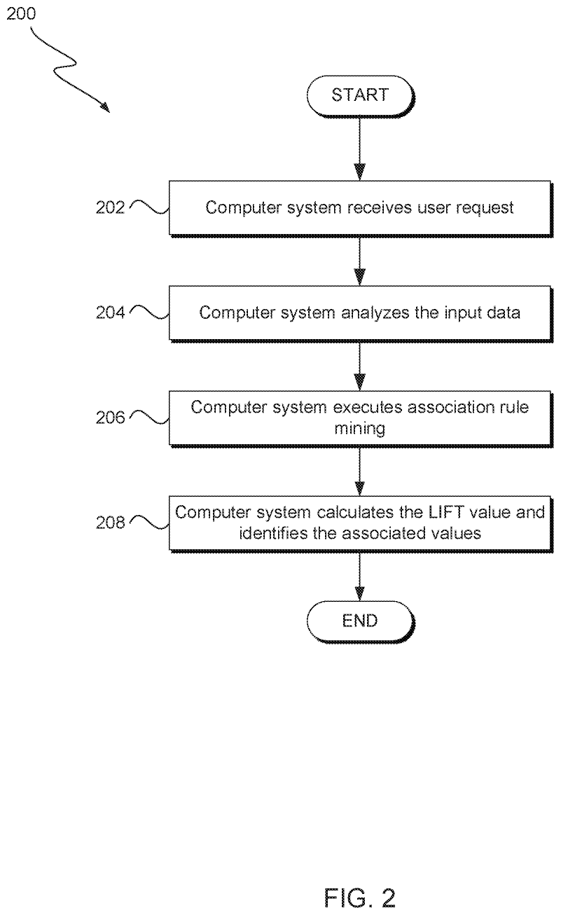

FIG. 2 is a flowchart, 200, depicting operations of association detection program 122 in computing environment 100, in accordance with an illustrative embodiment of the present invention. FIG. 2 also represents certain interactions between association detection program 122 and client application 132. In some embodiments, the operations depicted in FIG. 2 incorporate the output of certain logical operations of association detection program 122 executing on computer system 120. It should be appreciated that FIG. 2 provides an illustration of one implementation and does not imply any limitations with regard to the environments in which different embodiments may be implemented. Many modifications to the depicted environment may be made. In one embodiment, the series of operations in FIG. 2 can be performed in any order. In another embodiment, the series of operations, depicted in FIG. 2, can be terminated at any operation. In addition to the features previously mentioned, any operations, depicted in FIG. 2, can be resumed at any time.

In operation 202, association detection program 122 receives a user request regarding determinations made for a dataset. In various embodiments, association detection program 122 receives a request from a user of client device 130 to identify whether an association exists between values of a first attribute of the dataset and values of other attributes of the dataset, where the values of the first attribute have already been determined to receive partial output class determinations, and where the user wishes to identify whether any other attribute values are contributing to the partial output class determinations. In various embodiments, the user provides input data including (i) the output class(es) considered to be favorable, (ii) the first attribute, (iii) a first value of the first attribute which disproportionately results in unfavorable output class determinations, and (iv) a second value of the first attribute which disproportionately results in favorable output class determinations.

In operation 204, association detection program 122 analyzes the input data. In various embodiments, association detection program 122 performs a partiality analysis on the input data using a known metric for partiality analysis. For example, with one disparate impact metric, a disparate impact is determined when the ratio of favorable output class determinations for the first and second value of the first attribute is less than 0.8. Other examples of partiality analysis metrics include, but are not limited to, a statistical parity difference metric, an equal opportunity metric, and an average odds metric.

In various embodiments, association detection program 122 filters the dataset into two subsets (i) a first subset of data entries, having the first value of the first attribute and having received an unfavorable determination with regards to the output class and (ii) a second subset of data entries, having the second value of the first attribute and having received a favorable determination with regards to the output class. In various embodiments, association detection program 122 utilizes the first and second subsets of data entries to identify whether there is an association between the identified values of the first attribute and one or more associated attributes (i.e., a second attribute) with respect to a partial output class determination. Embodiments of the present invention provide that the filtering of the datasets is not limited to what is discussed above and that the datasets may include any combination of data entries based on their respective attribute values and/or output class determinations.

In operation 206, association detection program 122 executes an association rule mining model on the first subset of data entries and the second subset of data entries. In various embodiments, association detection program 122 trains the association rule mining by using known datasets and their respective associations as training data. For example, in various embodiments, the training data includes: (i) a schema identifying columns of a dataset and the respective constraints for each of the columns, and (ii) a list of known associations between columns.

In various embodiments, association detection program 122 provides the first subset of data entries and the second subset of data entries to the trained association rule mining model executing on computer system 120 to identify associations between the values of the first attribute and values of one or more additional attributes. In various embodiments, the trained association rule mining model analyzes the subsets and determines, at least, a second attribute associated with the values of the first attribute in the first and second subset. For example, in an embodiment, a third value of the second attribute is associated with the first value of the first attribute, and a fourth value of the second attribute is associated with the second value of the first attribute. In many cases, the trained association rule mining model determines a plurality of additional attributes, including the second attribute, having associations with the values of the first attribute.

In operation 208, association detection program 122 calculates a lift value for each of the additional attributes determined by the association rule model. In various embodiments, association detection program 122 calculates the lift value utilizing equation (1), discussed above. In various embodiments, association detection program 122 calculates a threshold lift value for the lift values of the associated attributes for each of the first and second subsets, where attributes having lift values above the threshold lift value are selected for further processing.

In various embodiments, association detection program 122 identifies the associated attributes for each of the first and second values of the first attribute. For example, based on the respective lift values of the additional attributes, association detection program 122 identifies a third value of a second attribute that is associated with the first value of the first attribute, and a fourth value of a third attribute that is associated with the second value of the first attribute. In various embodiments, association detection program 122 then determines whether partiality exists when the first and second value of the first attribute are combined with their respectively associated attribute values. In various embodiments, the determination of partiality in this operation uses the same metric (for example, a disparate impact metric, a statistical parity difference metric, an equal opportunity metric, or an average odds metric) used in operation 204, discussed above. For example, in various embodiments, a disparate impact is determined by taking the ratio of favorable determinations for the combination of the first value of the first attribute and the third value of the second attribute compared to the favorable determinations for the combination of the second value of the first attribute and the fourth value of the third attribute. In various embodiments, if the ratio is less than 0.8 than a disparate impact is present and a partiality in the determination of output classes exists.

In various embodiments, association detection program 122 communicates the determination of the disparate impact to the user of client device 130. In various embodiments, if a disparate impact exists, association detection program 122 communicates a summary of the data—including, for example, the first and second subsets—to the user of client device 130 with program instructions instructing client device 130 to coach the user to further analyze the data and make an informed decision of various parameters that could positively impact the partial determination identified. Embodiments of the present invention provide that the coaching of the user is provided to allow the user to make an impartial determination of the output class with respect to the first and second values of the first attribute and their respectively associated attribute values.

In one example embodiment, a computer decision algorithm selects work assignments for various employees of a corporation. In this example, the employees are divided into two workgroups. In this example, a manager believes that the employees one of the one of the two workgroups are receiving a disproportionate number of favorable work assignments, and would like to use association detection program to identify whether any other attributes may be contributing to the disproportionate assignments.

In the present example embodiment, association detection program 122 receives a user request from the manager to identify whether the two values of the “workgroup” attribute—Workgroup 1 and Workgroup 2—are associated with values of any other attributes, based on a dataset of work assignments. The user request also identifies which work assignments are considered favorable.

In the present example embodiment, association detection program 122 analyzes the input data—i.e., the “workgroup” attribute, its respective values (Workgroup 1 and Workgroup 2), and the identification of favorable assignments—to first determine whether the employees of one of the workgroups are receiving a statistically disproportionate share of favorable assignments. In this example, association detection program 122 determines that Workgroup 1 is being disparately impacted based on the ratio between Workgroup 1's favorable assignments and Workgroup 2's favorable assignments being less than 0.8. As a result, association detection program 122 creates two subsets of the work assignments dataset: (i) a first subset containing unfavorable work assignments to employees in Workgroup 1, and (ii) a second subset containing unfavorable work assignments to employees in Workgroup 2.

In the present example embodiment, association detection program 122 executes the association rule mining model on the first and second subset. The association rule mining model analyzes the subsets and determines, at least, a second attribute associated with the values of the first attribute—an “experience level” attribute. Association detection program 122 identifies that different values of the “experience level” attribute are associated with the different values of the “workgroup” attribute. Specifically, in this example, the “inexperienced” value of the “experience level” attribute is associated with the “Workgroup 1” value of the “workgroup” attribute, and the “experienced” value of the “experience level” attribute” is associated with the “Workgroup 2” value of the “workgroup” attribute.

In the present example, association detection program 122 calculates the lift values for: (i) the “inexperienced” value of the “experience level” attribute and the “Workgroup 1” value of the “workgroup” attribute, and (ii) the “experienced” value of the “experience level” attribute” and the “Workgroup 2” value of the “workgroup” attribute. In this example, association detection program 122 calculates the lift value utilizing equation (1), as discussed above. In this example, the lift value for (i) the “inexperienced” value of the “experience level” attribute and the “Workgroup 1” value of the “workgroup” attribute is above the lift value threshold, but the lift value for (ii) the “experienced” value of the “experience level” attribute” and the “Workgroup 2” value of the “workgroup” attribute is below the lift value threshold. Therefore, as a result, association detection program 122 selects the “inexperienced” value of the “experience level” attribute and the “Workgroup 1” value of the “workgroup” attribute for partiality analysis.

In the present example embodiment, association detection program 122 performs a partiality analysis for the combination of the “inexperienced” value of the “experience level” attribute and the “Workgroup 1” value of the “workgroup” attribute, to determine whether the inexperienced employees of Workgroup 1 are receiving a statistically disproportionate share of favorable assignments. Association detection program 122 uses the disparate impact metric, applied above, to determine that the ratio of favorable work assignments between inexperienced employees of Workgroup 1 and the other employees of the corporation is less than 0.8, resulting in a disparate impact. Association detection program 122 communicates this data to the manager with instructions instructing the manager to further analyze the data and make an informed decision on various parameters that could positively impact the work assignment determinations moving forward.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

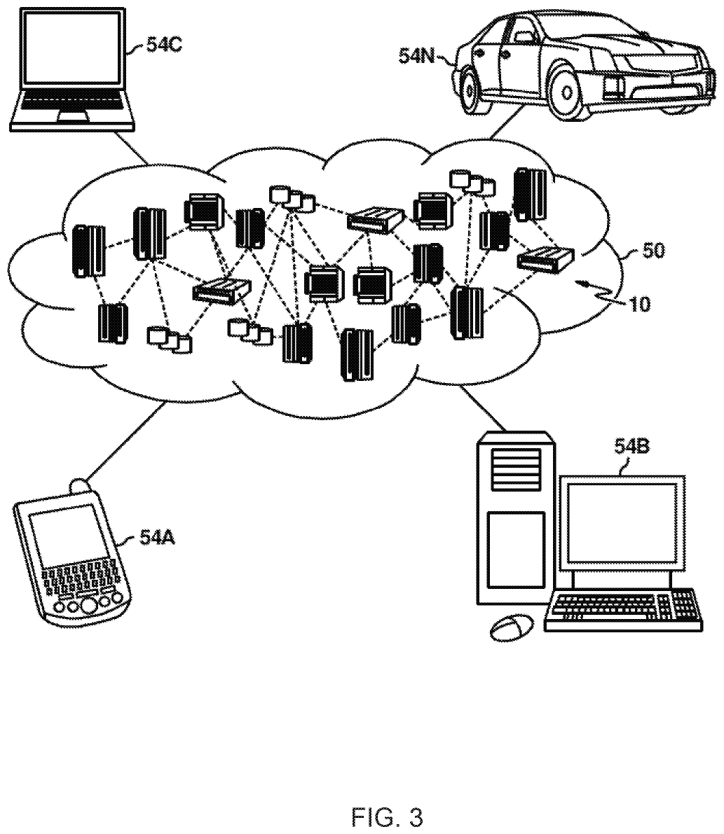

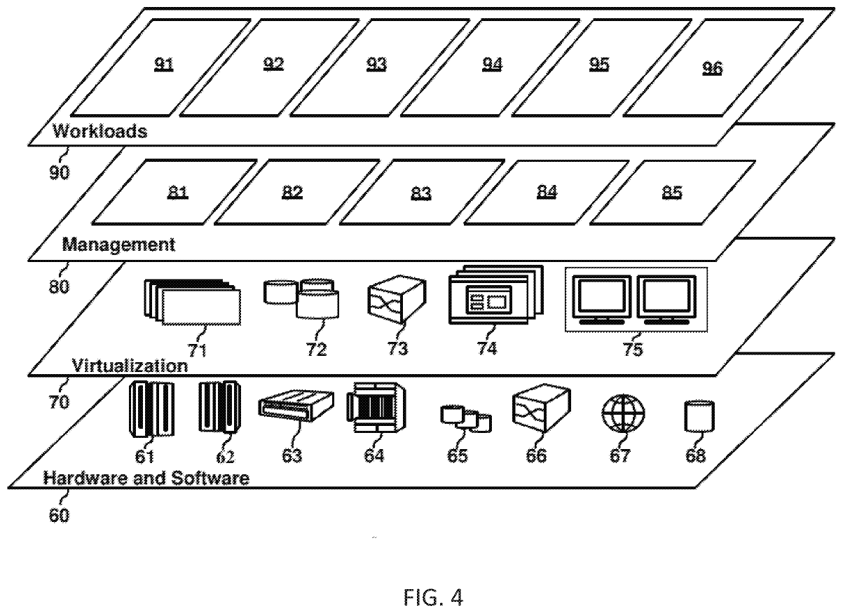

Referring now to FIG. 3, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 4, a set of functional abstraction layers provided by cloud computing environment 50 (FIG. 3) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing soothing output 96.

FIG. 5 depicts a block diagram, 500, of components of computer system 120, client device 130, SAN 140, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computer system 120 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Association detection program 122, computer interface 124, client application 132, client interface 134, server application 142, and database 144 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of network 110. In these examples, communications unit 510 includes one or more network interface cards. Communications unit 510 may provide communications through the use of either or both physical and wireless communications links. Association detection program 122, computer interface 124, client application 132, client interface 134, server application 142, and database 144 may be downloaded to persistent storage 508 through communications unit 510.

I/O interface(s) 512 allows for input and output of data with other devices that may be connected to computer system 120, client device 130, and SAN 140. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., association detection program 122, computer interface 124, client application 132, client interface 134, server application 142, and database 144, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as, for example, “Smalltalk” and the like may be subject to trademark rights in various jurisdictions throughout the world and are used here only in reference to the products or services properly denominated by the marks to the extent that such trademark rights may exist.

What is claimed is:

1. A computer-implemented method comprising:
identifying, by one or more processors, (i) a dataset, (ii) a set of output class determinations made for data entries of the dataset by a computer decision algorithm, and (iii) an undesired disparity between output class determinations resulting from a first value of a first attribute of the dataset and output class determinations resulting from a second value of the first attribute;
determining, by one or more processors, that a value of a second attribute of the dataset is contributing to the undesired disparity, by:
providing, to an association rule mining model: (i) a first group of the data entries having the first value of the first attribute, and (ii) a second group of the data entries having the second value of the first attribute, and
selecting the value of the second attribute from a set of candidate attributes and values produced by the association rule mining model based, at least in part, on a lift calculation.

2. The computer-implemented method of claim 1, the method further comprising:
receiving, by one or more processors, a request from a user to identify values of one or more attributes other than the first attribute that are contributing to the undesired disparity; and
responding, by one or more processors, to the request by informing the user of the determination that the value of the second attribute is contributing to the undesired disparity.

3. The computer-implemented method of claim 1, wherein determining that the value of the second attribute is contributing to the undesired disparity includes determining, by one or more processors, that the value of the second attribute is associated with the first value of the first attribute.

4. The computer-implemented method of claim 3, further comprising determining, by one or more processors, that a second value of the second attribute is also contributing to the undesired disparity, wherein the second value of the second attribute is determined to be associated with the second value of the first attribute.

5. The computer-implemented method of claim 3, further comprising determining, by one or more processors, that a value of a third attribute is also contributing to the undesired disparity, wherein the value of the third attribute is determined to be associated with the second value of the first attribute.

6. The computer-implemented method of claim 1, the method further comprising:
training, by one or more processors, the association rule mining model using training data that includes: (i) a schema identifying columns of a training dataset and respective constraints for each of the columns, and (ii) a list of known associations between the columns.

7. The computer-implemented method of claim 1, wherein the lift calculation includes dividing the number of data entries where the first value of the first attribute and the value of the second attribute co-occurred by the product of the number of data entries where the first value of the first attribute occurred and the number of data entries where the value of the second attribute occurred.

8. A computer program product, the computer program product comprising:
one or more computer-readable media and program instructions stored on the one or more computer-readable storage media, the stored program instructions comprising:
program instructions to identify (i) a dataset, (ii) a set of output class determinations made for data entries of the dataset by a computer decision algorithm, and (iii) an undesired disparity between output class determinations resulting from a first value of a first attribute of the dataset and output class determinations resulting from a second value of the first attribute;
program instructions to determine that a value of a second attribute of the dataset is contributing to the undesired disparity, by:
providing, to an association rule mining model: (i) a first group of the data entries having the first value of the first attribute, and (ii) a second group of the data entries having the second value of the first attribute, and
selecting the value of the second attribute from a set of candidate attributes and values produced by the association rule mining model based, at least in part, on a lift calculation.

9. The computer program product of claim 8, the stored program instructions further comprising:
program instructions to receive a request from a user to identify values of one or more attributes other than the first attribute that are contributing to the undesired disparity; and
program instructions to respond to the request by informing the user of the determination that the value of the second attribute is contributing to the undesired disparity.

10. The computer program product of claim 8, wherein the program instructions to determine that the value of the second attribute is contributing to the undesired disparity include program instructions to determine that the value of the second attribute is associated with the first value of the first attribute.

11. The computer program product of claim 10, the stored program instructions further comprising program instructions to determine that a second value of the second attribute is also contributing to the undesired disparity, wherein the second value of the second attribute is determined to be associated with the second value of the first attribute.

12. The computer program product of claim 10, the stored program instructions further comprising program instructions to determine that a value of a third attribute is also contributing to the undesired disparity, wherein the value of the third attribute is determined to be associated with the second value of the first attribute.

13. The computer program product of claim 8, the stored program instructions further comprising:
program instructions to train the association rule mining model using training data that includes: (i) a schema identifying columns of a training dataset and respective constraints for each of the columns, and (ii) a list of known associations between the columns.

14. The computer program product of claim 8, wherein the lift calculation includes dividing the number of data entries where the first value of the first attribute and the value of the second attribute co-occurred by the product of the number of data entries where the first value of the first attribute occurred and the number of data entries where the value of the second attribute occurred.

15. A computer system, the computer system comprising:
one or more processors;
one or more computer readable storage medium; and
program instructions stored on the computer readable storage medium for execution by at least one of the one or more processors, the stored program instructions comprising:
program instructions to identify (i) a dataset, (ii) a set of output class determinations made for data entries of the dataset by a computer decision algorithm, and (iii) an undesired disparity between output class determinations resulting from a first value of a first attribute of the dataset and output class determinations resulting from a second value of the first attribute;
program instructions to determine that a value of a second attribute of the dataset is contributing to the undesired disparity, by:
providing, to an association rule mining model: (i) a first group of the data entries having the first value of the first attribute, and (ii) a second group of the data entries having the second value of the first attribute, and
selecting the value of the second attribute from a set of candidate attributes and values produced by the association rule mining model based, at least in part, on a lift calculation.

16. The computer system of claim 15, the stored program instructions further comprising:
program instructions to receive a request from a user to identify values of one or more attributes other than the first attribute that are contributing to the undesired disparity; and
program instructions to respond to the request by informing the user of the determination that the value of the second attribute is contributing to the undesired disparity.

17. The computer system of claim 15, wherein the program instructions to determine that the value of the second attribute is contributing to the undesired disparity include program instructions to determine that the value of the second attribute is associated with the first value of the first attribute.

18. The computer system of claim 17, the stored program instructions further comprising program instructions to determine that a second value of the second attribute is also contributing to the undesired disparity, wherein the second value of the second attribute is determined to be associated with the second value of the first attribute.

19. The computer system of claim 18, the stored program instructions further comprising program instructions to determine that a value of a third attribute is also contributing to the undesired disparity, wherein the value of the third attribute is determined to be associated with the second value of the first attribute.

20. The computer system of claim 15, the stored program instructions further comprising:
program instructions to train the association rule mining model using training data that includes: (i) a schema identifying columns of a training dataset and respective constraints for each of the columns, and (ii) a list of known associations between the columns.
